(19) United States
(12) Patent Application Publication
(10) Pub. No.: US 2005/0175418 A1
(43) Pub. Date: Aug. 11, 2005

(54) Portable deer dressing and skinning device

(76) Inventor: Robert L. Johnson, Midlothian, VA (US)

Correspondence Address: ROBERT L. JOHNSON, 1610 OLD HUNDRED RD., MIDLOTHIAN, VA, 23114, US

(21) Appl. No.: 10/774,941

(22) Filed: Feb. 10, 2004

(51) Int. Cl. A22B 5/16

(52) U.S. Cl. 405/263

(57) ABSTRACT

A portable deer dressing and skinning device, that attaches to a truck or ATV trailer hitch, for easily field dressing a skinning a deer at the kill site, including a frame/body, a hitch pin, a winch, wire rope sheaves, galvanized wire, snap hooks, wire rope thimbles, a gambrel, and a lanyard.

### BACKGROUND OF THE INVENTION

The present invention generally relates to a portable deer field-dressing and skinning device, and more particularly, to a portable deer field-dressing and skinning device that would quickly and easily attach to a vehicle's or ATV's trailer hitch, and be easily removed when not in use.

Over the years, deer hunters have been field dressing their kills either on the ground or they drag or transport it back to camp where they can hang it up on a tree limb to make it easier to dress. Removing the skin from the deer is always a tedious and time consuming task. To date, there is no device that would allow a hunter to easily and quickly field dress and skin a deer carcass.

Therefore; it is idea of the present invention to do so.

### SUMMARY OF INVENTION

The invention is a device that attaches to a standard truck or ATV trailer hitch, allowing a deer to be hung in the air at the kill site for easy field dressing and skinning. The portable device would unfold and set up in seconds. Once the deer is attached to the device via a gambrel, it can be field dressed. Also, a lanyard is used to attach the deer skin to the gusset at the base of the device. When the winch is cranked, the skin is pulled from the deer as the carcass is raised.

The frame/body of the device may be manufactured from metal, plastic or other material. It may be fabricated or heated and bent.

The device would be easily removed from the hitch when not in use, fold up or break down, and be put away until needed again.

### BRIEF DESCRIPTION OF THE DRAWINGS

FIG. 10 shows a side perspective view of the device.

### DETAILED DESCRIPTION OF THE DRAWINGS

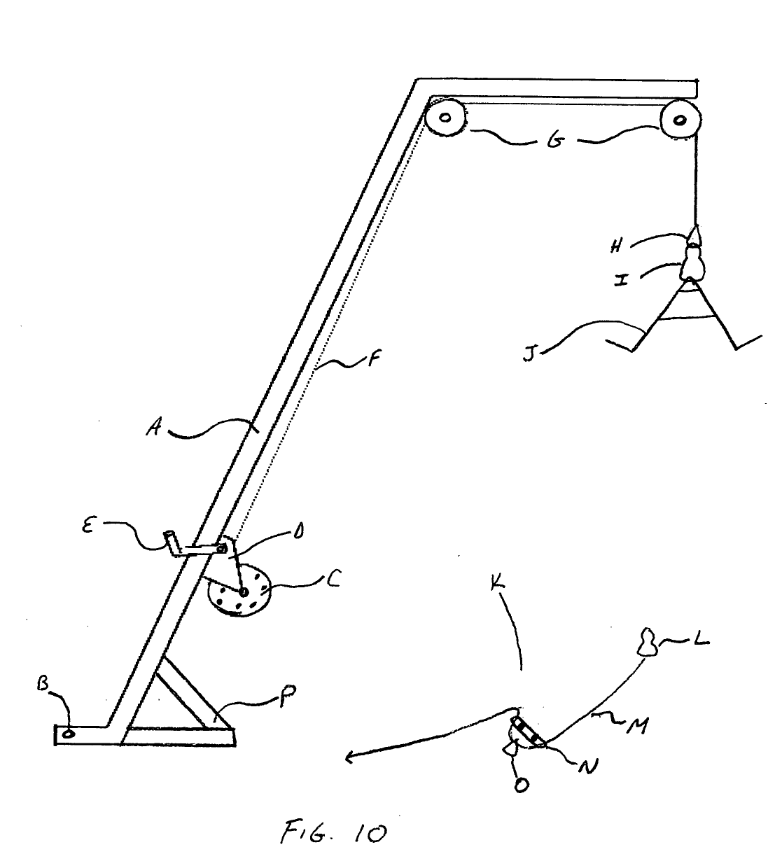

FIG. 10 shows a side perspective view of the device. It shows a frame/body A, a hitch attachment B that fits into a standard 2″ hitch and is secured with a hitch pin, a winch C complete with a mounting plate D and a handle E, galvanized wire rope cable F, wire rope sheaves with ball bearings G, a wire rope thimble H, a snap hook I, and a gambrel J which hold the deer carcass. A lanyard K, is attached to the deer and connected to the side of the trailer hitch as well. It includes a lanyard, which has a snap hook L, galvanized wire rope or braided nylon rope, a length adjustment device N, and a wire rope thimble O. The Lanyard attaches to the Gusset P at the base of the device.

1. A portable deer dressing and skinning device, that attaches to a truck or ATV trailer hitch, for easily field dressing and skinning a deer at the kill site, including:
a frame/body;
a hitch pin;
a winch;
wire rope sheaves;
galvanized wire, snap hooks, wire rope thimbles;
a gambrel;
a lanyard;

2. A portable deer dressing and skinning device as in claim 1, whereas the device is foldable, collapsible, telescoping or other method of making it more portable.
